(19) United States
(12) Patent Application Publication
(10) Pub. No.: US 2008/0270728 A1
(43) Pub. Date: Oct. 30, 2008

(54) BURST STRUCTURE ALLOCATION FOR PARALLEL CACHE PRE-LOADING

(75) Inventors: William Pohl, Morgan Hill, CA (US); Paul David Gootherts, Santa Clara, CA (US); Edward J. Sharpe, Los Gatos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/740,259

(22) Filed: Apr. 25, 2007

(51) Int. Cl. G06F 12/02

(52) U.S. Cl. 711/170

(57) ABSTRACT

A method of allocating memory and a memory allocation apparatus are described. The method comprises allocating a set of memory locations for at least a portion of a data structure, wherein the allocated set comprises memory space storing a counter corresponding to each memory location in the set. A method of traversing a data structure is described. The method comprises incrementing, by a predetermined value, a reference address of a pointer to a first data structure of a portion of a set of allocated memory locations to obtain a reference address to a second data structure in the portion of the set. The portion of the set of allocated memory locations comprises a counter for each allocated memory location.

### BACKGROUND

A linked list data structure comprises one or more data structures where each data structure comprises at least one pointer reference to the next data structure in the linked list data structure. During execution, a processor might not load all data structures of a linked list data structure into cache, e.g., a processor cache. During traversal of the portion of the linked list data structure loaded into cache, following each pointer reference to a new element of the linked list data structure risks a cache miss, i.e., the next data structure might not have been loaded into cache.

When a cache miss occurs, a serial load of the next structure in the linked list data structure from memory to cache is performed. It is not until the data structure is loaded, that the next structure is referenced and brought into the cache. The serial loading of data structures in the linked list data structure is repeated until the desired amount of the list is loaded into cache.

Accordingly, each cache miss occurs serially incurring the overhead and latency required to load in each individual data structure.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level functional diagram of a portion of a computer system usable in conjunction with an embodiment;

FIG. 2 is a high-level process flow diagram of a portion of a method according to an embodiment;

FIG. 3 is a high-level process flow diagram of another portion of a method according to an embodiment; and

FIG. 4 is a high-level process flow diagram of a portion of a method according to another embodiment.

### DETAILED DESCRIPTION

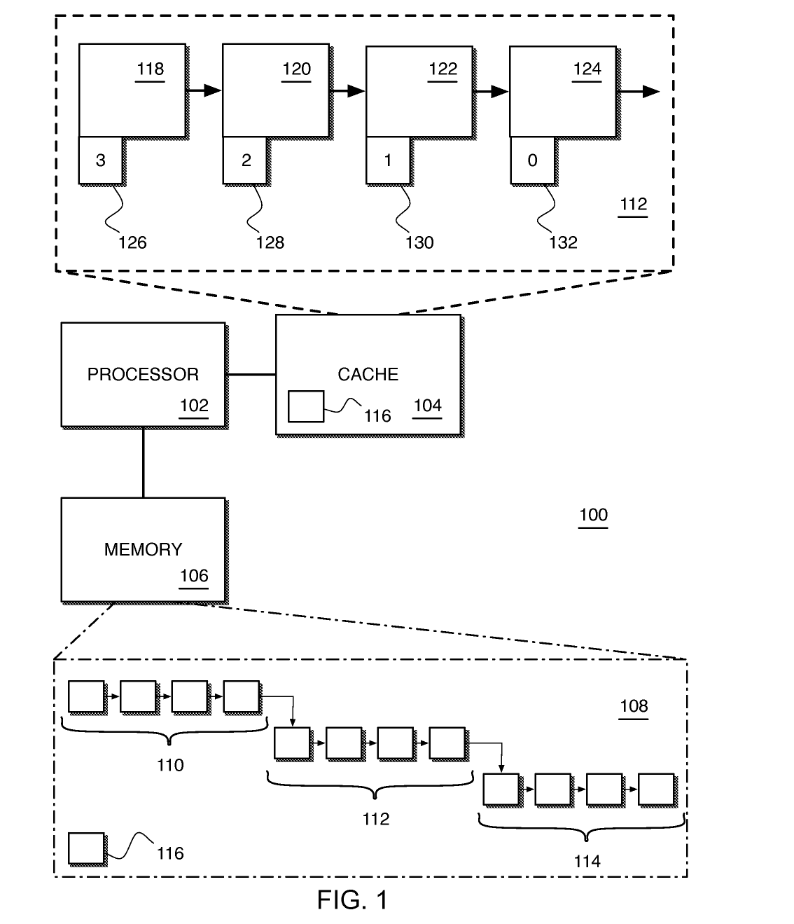

FIG. 1 depicts a high-level functional diagram of a portion of a computer system 100 usable in conjunction with an embodiment. Computer system 100 comprises a processor 102, a cache 104 communicatively coupled with the processor, and a memory 106 communicatively coupled with the processor. Processor 102 executes a set of instructions, e.g., executable software stored in cache 104, memory 106, etc., which cause the processor to perform operations, e.g., reading and/or writing values from/to elements of computer system 100, e.g., cache 104, memory 106, etc. At least one operation performed by processor 102 is an allocation of memory locations in memory 106 for use by executable software executed by the processor.

In at least some embodiments, memory 106 may comprise volatile and/or non-volatile memory, e.g., read-only memory, random access memory, etc. In at least some embodiments, processor 102 and cache 104 may be combined into a single element of computer system 100. In at least some embodiments, processor 102, cache 104, and memory 106 may be communicatively coupled via a bus.

A particular type of memory location allocation is referred to as a “burst allocation.” A burst allocation refers to an allocation of memory locations for several data structures at one time in memory 106 in response to a requested allocation of memory for several data structures. Instead of allocating each individual requested data structure one at a time, a burst allocation causes the allocation of a set of memory locations for several data structures at a time.

In at least some embodiments, the allocated set of memory locations is a set of sequential memory locations, e.g., a memory address referenced by a pointer to a first memory location may be incremented by one in order to obtain a second memory location. Given a burst allocation of a linked list structure, i.e., wherein each element of the linked list structure comprises a pointer to the next element of the linked list, to a sequential set of memory locations, the pointers of the linked list need not be used in order to traverse the sequentially allocated set of memory locations. In this manner, an embodiment may reduce the time to traverse a linked list structure.

In at least some embodiments, the burst allocation is divided into segments based on a predetermined segment size. A given requested allocation of more than one data structure is divided into a number of segments each comprising one or more data structures. Each segment is allocated a set of memory locations. In accordance with at least some embodiments, each segment is allocated a set of sequential memory locations for a particular data structure type.

FIG. 1 depicts a set 108 (indicated by dash-dot line) of allocated data structures in memory 106 corresponding to a requested memory allocation for a linked list data structure. Set 108 comprises three segments 110, 112, 114 of allocated data structures in memory 106. As depicted, each segment comprises four sequentially allocated structures in memory 106. In at least some embodiments, segments 110, 112, 114 are sequentially allocated data structures in memory 106. In at least some embodiments, segments 110, 112, 114 comprise a greater or lesser number of allocated data structures.

Segments 110, 112, 114 comprise the requested memory allocation for the linked list data structure. As depicted, the allocation comprised by segments 110, 112, 114 is not a contiguous memory addressing space, however, each segment 110, 112, 114 comprises a sequential contiguous memory addressing space, i.e., the allocated data structures comprising segment 110 comprise sequential memory locations in memory 106.

Memory 106 also comprises a predetermined segment size 116 specifying the maximum number of data structures to be allocated in a particular segment. In at least some embodiments, predetermined segment size 116 is specified based on a user input and/or the results of empirical analysis. In at least some embodiments, predetermined segment size 116 may be determined based on memory page boundaries and/or cache line sizes.

FIG. 1 depicts segment 112 (indicated by dashed lines) of set 108 and predetermined segment size 116 stored in cache 104 for access by processor 102. Segment 112, corresponding to segment 112 allocated in memory 108, comprises four sequentially allocated data structures 118-124 comprising a portion of the requested memory allocation for a linked list data structure.

Segment 112 further comprises counters 126-132 associated with a respective allocated data structure 118-124. Counters 126-132, respectively, store a value representing the position of the data structure within segment 112. For example, counter 126 of data structure 118 comprises a three value (“3”) indicating that there are three data structures remaining within segment 112, counter 128 of data structure 120 comprises a two value (“2”) indicating two remaining data structures, counter 130 of data structure 122 comprises a one value (“1”) indicating one remaining data structure, and counter 132 of data structure 124 comprises a zero value (“0”) indicating the data structure is the last structure within segment 112.

Based on the value of data structure counters 126-132, the number of remaining data structures in segment 112 may be determined. In addition, the position of the data structure within segment 112 may be determined based on the value of data structure counters 126-132. For example, subtracting the counter value from the predetermined segment size value yields the position of the particular data structure within segment 112.

In at least some embodiments, counters 126-132 are a part of the respective data structures 118-124.

Given a sequential allocation of data structures in segment 112, data structures 118-124 of the segment may be traversed by incrementing the reference address to data structure 118 by an appropriate amount based on the desired data structure. For example, incrementing a reference address to data structure 118 by a value of two (“2”) times the size of the data structure, in order to obtain the data structure two positions away from data structure 118, yields a reference address to data structure 122.

In order to obtain the data structure to which data structure 124 is linked in the linked list data structure, segment 114 is loaded into cache 104 from memory 106.

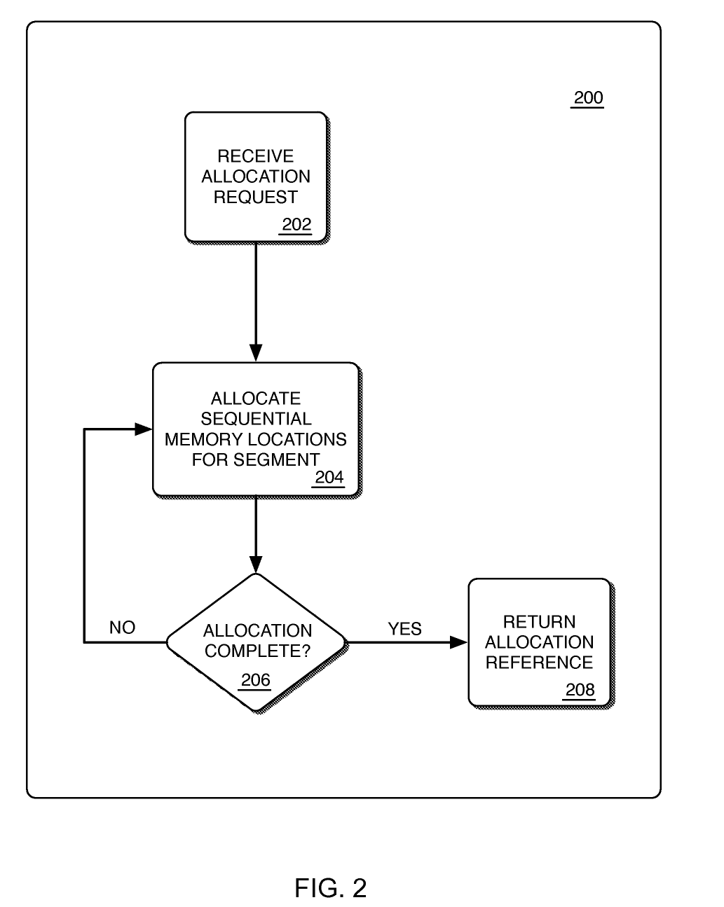

FIG. 2 depicts a high-level process flow diagram of an allocating portion 200 of a method according to an embodiment. Allocating portion 200 comprises a set of instructions which, when executed by processor 102, cause the processor to perform the following operations.

The process flow begins at a receive request functionality 202 wherein a request for a memory allocation corresponding to a set of data structures is received, e.g., a request for a memory allocation for a linked list data structure of a given size. The flow proceeds to an allocate segment functionality 204 wherein processor 102 allocates sequential memory locations in memory 106 corresponding to a segment based on predetermined segment size 116. For example, given a predetermined segment size value of four (“4”), allocating portion 200 allocates up to four sequential memory locations to a first segment in order to fulfill the requested allocation.

During allocate segment functionality 204, processor 102 allocates a memory address space for the requested data structure, e.g., an element of the linked list data structure such as data structure 118, and a counter 126. In at least some embodiments, memory for storing counter 126 may be a part of data structure 118. In at least some embodiments, processor 102 allocates an amount of memory in addition to the memory allocation needed for data structure 118 in order to store counter 126. Processor 102 executing allocate segment functionality 204 stores a value in the counter associated with each allocated data structure. In at least some embodiments, processor 102 stores a value in the counter based on the position of the data structure within segment 112, i.e., processor 102 initializes the counter value. In at least some embodiments, processor 102 stores a incrementally increasing value in the counter for each data structure in a given segment.

After allocating a given segment, the flow proceeds to a complete determination functionality 206 wherein processor 102 determines whether the memory allocation is complete, i.e., whether the memory allocated equals the requested memory allocation. If the outcome of complete determination functionality 206 is positive (“YES” or true), i.e., the requested memory allocation has been satisfied, the flow proceeds to return functionality 208 and a reference to the allocated memory is returned to the requestor, e.g., a particular process. If the outcome of complete determination functionality 206 is negative (“NO” or false), i.e., the requested memory allocation has not been satisfied, the flow proceeds to return to allocate segment functionality 204.

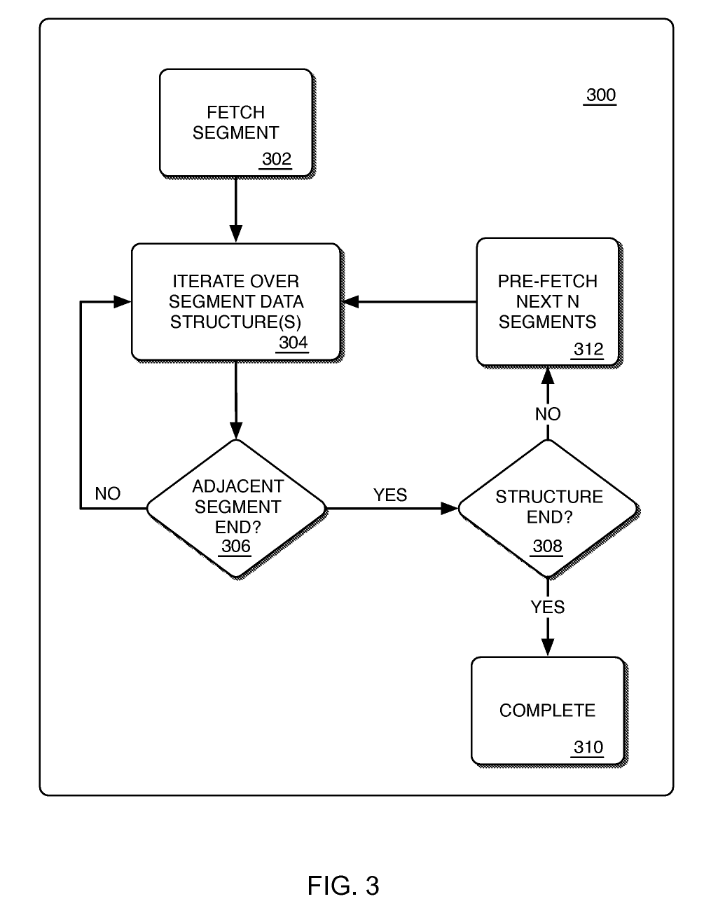

FIG. 3 depicts a high-level process flow diagram of an iterating portion 300 of a method according to an embodiment. Iterating portion 300 comprises a set of instructions which, when executed by processor 102, cause the processor to perform the following operations. Iterating portion 300 traverses the linked list data structure. In at least some embodiments, iterating portion 300 is used in combination with one or more additional functions to perform one or more functions on each data structure in the linked list data structure.

The process flow begins at a fetch segment functionality 302 wherein execution of the set of instructions by processor 102 causes a segment, e.g., first segment 110, to be read from memory 106 to cache 104. The flow proceeds to iteration functionality 304.

During iteration functionality 304, processor 102 traverses data structures of segment 110 by incrementing the reference address to the data structure. In at least one embodiment, iteration functionality 304 may perform one or more functions on each data structure being traversed.

The flow proceeds to adjacent end functionality 306 wherein processor 102 determines whether the end of the segment has been reached. In at least one embodiment, processor 102 determines whether the processor is near the end of the segment based on the value of the counter corresponding to the data structure being traversed.

If the outcome of adjacent end functionality 306 is positive (“YES” or true), the flow proceeds to structure end determination functionality 308. If the outcome of adjacent end functionality 306 is negative (“NO” or false), the flow proceeds to return to iteration functionality 304 for the next data structure of the segment.

During structure end determination functionality 308, processor 102 determines whether the end of the allocated data structure, e.g., the end of the linked list data structure, has been reached. In at least some embodiments, processor 102 determines whether the end of the linked list data structure has been reached by determining whether the link to the succeeding data structure is either invalid, null, and/or a predetermined indicative value.

If the outcome of structure end determination functionality 308 is positive (“YES” or true), the flow proceeds to complete functionality 310 and iterating portion 300 ends. If the outcome of structure end determination functionality 308 is negative (“NO” or false), the flow proceeds to pre-fetch next segment functionality 312.

During pre-fetch next segment functionality 312, the succeeding segment, i.e., segment 112, is read from memory 106 to cache 104, i.e., the data structures comprising the succeeding segment are loaded into cache. The flow of control proceeds to return to iteration functionality 304 and proceeds as described above.

In at least some embodiments, during pre-fetch next segment functionality 312, processor 102 reads a predetermined number of succeeding segments (N segments) from memory 106. In at least some embodiments, the predetermined number of succeeding segments read by processor 102 is the number of segments remaining in a set 108 or a maximum number of segments which the processor is able to fetch, e.g., based on processor instructions, etc.

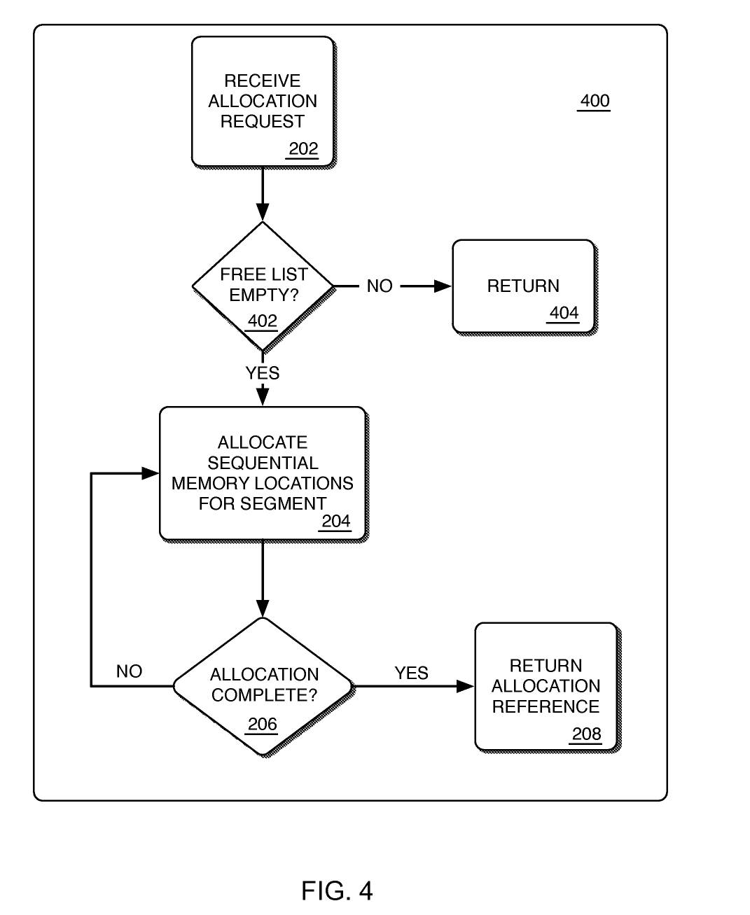

FIG. 4 depicts a high-level process flow diagram of an allocating portion 400 of a method according to another embodiment similar to the FIG. 2 embodiment. Allocating portion 400 differs from the FIG. 2 embodiment in comprising a free list check functionality 402 executed subsequent to the receive request functionality 202. In order to avoid memory fragmentation in a segment, processor 102 executes free list check functionality 402 to check a list of available data structures, i.e., available data structures maintained on a “free list,” prior to allocating memory locations for a segment.

Similar to FIG. 2, the FIG. 4 process flow begins at receive request functionality 202 wherein a request for a memory allocation corresponding to a set of data structures is received, e.g., a request for a memory allocation for a linked list data structure of a given size. The flow proceeds to free list check functionality 402 wherein a free list, e.g., maintained in memory 106 and/or cache 104, is checked to determine whether a data structure is available to satisfy at least a portion of the received request. If the result of check free list functionality 402 is negative indicating the existence of an available data structure for allocation (“NO” path), the flow of control proceeds to return functionality 404 and processor 102 satisfies at least a portion of the allocation request using the available data structure. If the result of check free list functionality 402 is positive indicating the lack of an available data structure for allocation (“YES” path), the flow of control proceeds to allocate segment functionality 204 and the flow proceeds as described above with respect to allocating portion 200 of FIG. 2.

What is claimed is:

1. A method of allocating memory, comprising:
allocating a set of memory locations for at least a portion of a data structure, wherein the allocated set comprises memory space storing a counter corresponding to each memory location in the set.

2. The method as claimed in claim 1 wherein the allocating comprises allocating a sequential set of memory locations.

3. The method as claimed in claim 1 wherein the allocating comprises allocating memory locations for at least a portion of a linked list data structure.

4. The method as claimed in claim 1 wherein the allocating further comprises populating a portion of the allocated set with a counter value for each allocated memory location.

5. The method as claimed in claim 4 wherein the populating comprises populating by use of at least one of an incrementally increasing value and an incrementally decreasing value.

6. The method as claimed in claim 5 wherein the populating further comprises populating based on a position of the allocated memory location within the allocated set.

7. The method as claimed in claim 1 further comprising:
dividing a data structure for which a memory allocation is requested into a number of segments.

8. The method as claimed in claim 7 wherein the dividing is performed based on a predetermined segment size.

9. The method as claimed in claim 7 further comprising:
repeating the allocating for each segment of the divided data structure.

10. The method as claimed in claim 7 wherein the allocating comprises allocating a sequential set of memory locations.

11. The method as claimed in claim 7 wherein the allocating further comprises populating a portion of the allocated set with a counter value for each allocated memory location.

12. The method as claimed in claim 11 wherein the populating comprises populating by use of at least one of an incrementally increasing value and an incrementally decreasing value.

13. The method as claimed in claim 12 wherein the populating further comprises populating based on a position of the allocated memory location within the allocated set.

14. A memory or a computer-readable medium storing instructions which, when executed by a processor, cause the processor to allocate a set of memory locations for at least a portion of a data structure, wherein the allocated set comprises memory space arranged to store a counter corresponding to each memory location in the set.

15. A memory allocation apparatus, comprising:
a processor;
a memory communicatively coupled with the processor and comprising sequences of instructions which, when executed by the processor, cause the processor to allocate a set of memory locations for at least a portion of a data structure, wherein the allocated set comprises memory space arranged to store a counter corresponding to each memory location in the set.

16. A method of traversing a data structure, comprising:
incrementing, by a predetermined value, a reference address of a pointer to a first data structure of a portion of a set of allocated memory locations to obtain a reference address to a second data structure in the portion of the set, wherein the portion of the set of allocated memory locations comprises a counter for each allocated memory location.

17. The method as claimed in claim 16 wherein the incrementing is performed based on at least one counter value.

18. The method as claimed in claim 16 wherein the incrementing further comprises applying a function to a portion of at least one of the first data structure and the second data structure.

19. The method as claimed in claim 16 further comprising:
fetching a segment comprising a portion of data structures of the set of allocated memory locations.

20. The method as claimed in claim 19 wherein the fetching comprises fetching a segment comprising a portion of data structures of the set of allocated memory locations based on a predetermined segment size.
